(19) United States
(12) Patent Application Publication
(10) Pub. No.: US 2018/0196861 A1
(43) Pub. Date: Jul. 12, 2018

(54) METHOD FOR GENERATING GRAPH DATABASE OF INCIDENT RESOURCES AND APPARATUS THEREOF

(71) Applicant: KOREA INTERNET & SECURITY AGENCY, Seoul (KR)

(72) Inventors: Seul Gi Lee, Seoul (KR); Hyei Sun Cho, Seoul (KR); Nak Hyun Kim, Seoul (KR); Byung Ik Kim, Seoul (KR); Tae Jin Lee, Seoul (KR)

(21) Appl. No.: 15/420,666

(22) Filed: Jan. 31, 2017

(30) Foreign Application Priority Data
Jan. 6, 2017 (KR) 10-2017-0002459

(51) Int. Cl. G06F 17/30

(52) U.S. Cl. CPC G06F 17/30569; G06F 17/30958

(57) ABSTRACT

Disclosed are methods, apparatus and programs for generating graph database of incident resources, one of the methods comprises receiving an incident resource data set, extracting valid incident resource information from the incident resource data set, setting a resource ID for a incident resource included in the valid incident resource information, setting each attribute ID for a plurality of constituent elements of the incident resource, setting a relationship between the incident resource in which the resource ID is set and the plurality of constituent elements in which the attribute ID is each set, generating a resource node of the incident resource based on the resource ID, generating each attribute node of the plurality of constituent elements based on the attribute ID, and generating a graph database in which the resource node and the attribute node are connected to each other by an edge indicating the set relationship.

This application claims priority from Korean Patent Application No. 10-2017-0002459 filed on Jan. 6, 2017 in the Korean Intellectual Property Office, the disclosure of which is incorporated herein by reference in its entirety.

### BACKGROUND OF THE INVENTION

### 1. Field of the Invention

The present invention relates to a method for generating graph database of incident resources and an apparatus thereof. More particularly, the present invention relates to a method and apparatus for dividedly managing constituent elements of incident resources and generating a graph database of the constituent elements of the incident resources.

### 2. Description of the Related Art

Information relating to infringement accidents is shared between domestic and foreign public institutions and private companies to respond to the rapidly increasing infringement accidents. Furthermore, various methods have been attempted to previously defend attacks of incident resources, by refining and managing information on shared infringement accidents as intelligence information.

As an example of a method for refining and managing intelligence information, there is a method for dividing the constituent elements of incident resources to build the relationship between the incident resources and the constituent elements, and the relationship between the constituent elements and the constituent elements in a relational database (RDB), thereby deriving the intelligence information.

However, in a case where the intelligence information of the incident resources is managed by the relational database, when determining the correlation between the plurality of incident resources, since it is necessary to inquire and compare all the constituent elements, there is a problem of very complication of a calculation process. Also, due to the characteristics of the relational database, there is a problem in which it is difficult to intuitively check the relationship between the incident resources and the constituent elements, and the relationship between the constituent elements and the constituent elements from the standpoint of management.

Nevertheless, there is no method for minimizing the calculation process, and capable of visually expressing the relationship between incident resources and the constituent element in a graphs relation, by building a graph database between the incident resources and using each constituent element of incident resources as nodes and analyzing the correlation.

### SUMMARY OF THE INVENTION

According to the embodiment of the present invention described above, there is an advantage that the relationship between the incident resources and the constituent elements can be intrusively analyzed by managing the incident resources with a graph database. Specifically, there is an effect capable of analyzing the distance-based correlation between the incident resources through the graph database according to the embodiment of the present invention.

Also, according to an embodiment of the present invention, there is an effect capable of minimizing calculation process for comparison among the constituent elements of incident resources when analyzing correlation between the incident resources, by utilizing a graph database. Further, since each constituent element is represented by a node on the graph database according to an embodiment of the present invention, it is possible to minimize the time required for the correlation analysis between the incident resources by utilizing the connection relationship between the respective nodes.

The effects of the present invention are not limited to those mentioned above, and other effects which have not been mentioned will be clearly understood by to one of ordinary skill in the art to which the present invention belongs from the following description.

According to some embodiments of the present disclosure, a method for generating graph database of incident resources is provided, the method comprises receiving an incident resource data set, extracting valid incident resource information from the incident resource data set, setting a resource ID for a incident resource included in the valid incident resource information, setting each attribute ID for a plurality of constituent elements of the incident resource, setting a relationship between the incident resource in which the resource ID is set and the plurality of constituent elements in which the attribute ID is each set, generating a resource node of the incident resource based on the resource ID, generating each attribute node of the plurality of constituent elements based on the attribute ID, and generating a graph database in which the resource node and the attribute node are connected to each other by an edge indicating the set relationship.

According to some embodiments of the present disclosure, wherein setting each attribute ID for the plurality of constituent elements of the incident resources comprises extracting meta data of the incident resource, dividing the string of the extracted meta data into a first string and a second string, determining the first string and the second string as the constituent elements of the incident resource, and setting the attribute ID in each of the first string and the second string.

According to some embodiments of the present disclosure, wherein setting the resource ID for the incident resource included in the valid incident resource information comprises extracting meta data of the incident resource, determining whether a preset semantic-based type is identified to the string of the extracted meta-data, executing a pattern analysis of a string of the meta data, when the preset semantic-based type is not identified as a result of determination, and generating a pattern type of the string of the meta data, based on the execution result of the pattern analysis, wherein the generating the resource node of the incident resource based on the resource ID comprises adding information on the generated pattern type to the value of the generated resource node.

According to some embodiments of the present disclosure, wherein the setting the resource ID for the incident resources comprises determining whether there is a first incident resource duplicated with the incident resource on the valid incident resource information, based on a value of the incident resource, and setting the resource ID in the incident resource, when there is no first incident resource duplicated with the incident resource, as a result of the determination.

According to some embodiments of the present disclosure, wherein the generating each attribute node for the plurality of constituent elements based on the attribute ID comprises comparing values of a first attribute node and a second attribute node included in the generated attribute node with each other, specifying the first pattern type to the first attribute node and specifying the second pattern type to the second attribute node, when the value of the first attribute node is equal to the value of the second attribute node as a result of the determination, and generating the first attribute node and the second attribute node, when the first pattern type and the second pattern type are different from each other.

According to some embodiments of the present disclosure, wherein the extracting the valid incident resource information from the incident resource data set comprises applying a preset regular expression to the received incident resource data set, and determining preset information, among information included in the incident resource data set to which the regular expression is applied, as the valid incident resource information.

According to some other embodiments of the present disclosure, a computer program, for generating a graph database of incident resources, which is coupled with a computer device and stored in a non-transitory computer readable recording medium, is provided, the program being configured to execute receiving an incident resource data set, extracting valid incident resource information from the incident resource data set, setting a resource ID for the incident resource included in the valid incident resource information, setting an attribute ID for a constituent element of the incident resource, setting a relationship between the incident resource in which the resource ID is set and the constituent element in which the attribute ID is set, generating a resource node of the incident resource based on the resource ID, generating an attribute node of the constituent element based on the attribute ID, and generating a graph database in which the resource node and the attribute node are connected to each other by an edge indicating the set relationship.

According to some other embodiments of the present disclosure, an apparatus for generating graph database of incident resources is provided, the apparatus comprises one or more processors, a memory configured to load a computer program executed by the processors, a network interface configured to receive an incident resource data set from the collection system, and a storage configured to store the computer program and the incident resource data set, wherein the computer program comprises an operation of receiving the incident resource data set, an operation of extracting valid incident resource information from the incident resource data set, an operation of setting a resource ID for the incident resource included in the valid incident resource information, an operation of setting an attribute ID for each of the plurality of constituent elements of the incident resource, an operation of setting a relationship between the incident resource in which the resource ID is set and the plurality of constituent elements in which the attribute ID is set, an operation of generating a resource node of the incident resource, based on the resource ID, an operation of generating attribute node for each of the plurality of constituent elements based on the attribute ID, and an operation of generating a graph database in which the resource node and the attribute node are connected to each other by edge indicating the set relationship.

### BRIEF DESCRIPTION OF THE DRAWINGS

The above and other aspects and features of the present invention will become more apparent by describing in detail exemplary embodiments thereof with reference to the attached drawings, in which:

FIG. 1 is a block diagram of a generating system of a graph database of incident resources according to an embodiment of the present invention;

FIG. 2 is a hardware block diagram of an apparatus for generating a graph database of the incident resources according to another embodiment of the present invention;

FIG. 3 is a flowchart of a method for generating a graph database of the incident resources according to still another embodiment of the present invention;

FIG. 4 is an exemplary view for illustrating nodes of a graph database, which are referred to in some embodiments of the present invention;

FIG. 5 is an exemplary view for illustrating a divisional management method of incident resources when the incident resource is a URL, which is referred to in some embodiments of the present invention;

FIG. 6 is an exemplary view of a graph generated when the incident resource is a URL, which is referred to in some embodiments of the present invention;

FIG. 7 is an exemplary view for illustrating a divisional management method of incident resources when the incident resource is an E-mail, which is referred to in some embodiments of the present invention;

FIG. 8 is an exemplary view of a graph generated when the incident resource is E-mail, which is referred to in some embodiments of the present invention;

FIG. 9 is an exemplary view of a method of specifying additional pattern types for the incident resource, which is referred to in some embodiments of the present invention;

FIG. 10 is an exemplary view for illustrating a relationship between a resource node and an attribute node according to the division result of the incident resource, which is referred to in some embodiments of the present invention; and

FIG. 11 is an example of a graph database which is referred to in some embodiments of the present invention.

### DETAILED DESCRIPTION OF THE INVENTION

Embodiments of the present inventive concept will hereinafter be described in detail with reference to the attached drawings. The advantages and features of the present inventive concept and methods for accomplishing the same will become apparent by referring to the preferred embodiments thereof described below with reference to the attached drawings. The present inventive concept may, however, be embodied in different forms and should not be construed as limited to the embodiments set forth herein. Rather, these embodiments are provided so that this disclosure will be thorough and complete, and the present inventive concept will be defined by the scope of claims. Throughout the description, identical reference numerals are used to designate identical elements.

Unless defined otherwise, all terms (including technical and scientific terms) used herein have the same meaning as commonly understood by one of ordinary skill in the art to which the present inventive concept belongs. Further, unless expressly defined otherwise, all terms defined in generally used dictionaries may not be interpreted in an idealized or overly sense. It will also be understood that the terms may be used herein to describe embodiments, and may not intended to limit the scope of the present disclosure. As used herein, the singular forms are intended to include the plural forms as well, unless the context clearly indicates otherwise.

In the present specification, the infringement accident refers to a case where malicious activity is executed on the assets that constitute an information processing system. Further, incident resources are all kinds of information related to infringement accidents such as malicious activator, infrastructure for malicious activity and malicious tool, and may include, for example, IP, domain, E-mail, malicious code and the like.

Hereinafter, the present invention will be described in more detail with reference to the accompanying drawings.

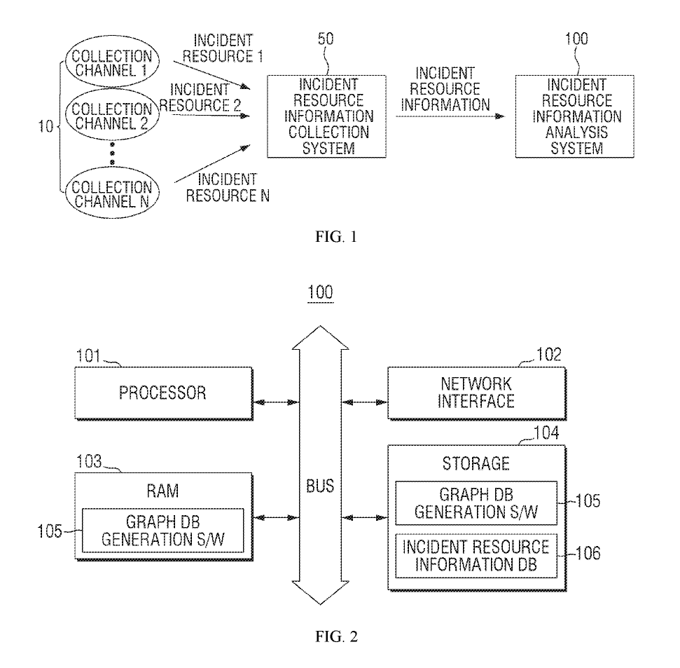

FIG. 1 is a block diagram of a graph database generation system of incident resources according to an embodiment of the present invention.

Referring to FIG. 1, the graph database generation system of incident resources may include one or more collection systems 50 and analysis systems 100. The graph database generation system of the incident resources may be, for example, an accumulated and integrated intelligence system (AEGIS). The collection system 50 and the analysis system 100 may be systems that include at least one computing device connected via the network and capable of communicating with each other.

The collection system 50 may collect various types of information on the incident resources (incident resource 1, incident resource 2, . . . , incident resource n) that cause the infringement accident from various collection channels (collection channel 1, collection channel 2, . . . , collection channels n) 10. The collection channel may be, for example, a shared channel of information related to incident resources, e.g., websites such as virusshare.com, a cyber black box or the like.

The collection system 50 may collect information on the incident resources associated with the infringement accident and may receive the information periodically or non-periodically from the collection channel 10. For example, if the incident resource is a malicious code, the collection system 50 may receive a hash value of malicious code, and if the incident resource is a url of a specific website, the collection system 50 may receive url and information on domains. The information on the incident resource received from the collection channel 10 by the collection system 50 may be an incident resource data set. The formats of the incident resource data set may be different for each collection channel that collects the information on the infringement incident. For example, when the incident resource is a malicious code, the incident resource data set may be information in a table format including hash values of a large number of malicious codes and collected channel information.

In addition, the collection system 50 may actively ask the collection channel 10 for information on the incident resource that causes the specific infringement accident and may receive the information. That is, it is also possible to actively collect incident resources based on input entered by the administrator and/or the user of the generation system of the graph database of the incident resources. In the above example, if the incident resource is a malicious code, the collection system 50 may actively collect information on the string as a constituent element of the hash value and information on the channel to which the hash value is attached, on the basis of the hash value entered by the administrator and/or the user of the generation system of the graph database of the incident resources, when the hash value is received.

The analysis system 100 may divisionally manage the incident resources collected from the collection system 50. In particular, since the format of the incident resource data set collected from the collection system 50 may be different for each collection channel that collects the incident resource, the analysis system 100 may store information on the incident resources in a unified data format by applying a regular expression to the incident resource data set.

The analysis system 100 may generate dividedly managed incident resources in a graph database and may store the generated graph database. In this manner, as the graph database is generated, the user of the analysis system 100 may intuitively determine the correlation between the plurality of incident resources, by analyzing the relationship between each node on the visually provided graph database.

According to an embodiment of the present invention, the analysis system 100 regularly expresses the incident resource data set, and may generate a graph database of incident resources by configuring the incident resources and the constituent elements of incident resources as nodes. Only in such an embodiment, the analysis system 100 according to the embodiment of the present invention may also be referred to as a graph database generating apparatus of incident resources.

The graph database generation system of the incident resources may further include another computing device, in addition to the collection system 50 and the analysis system 100. For example, the graph database generation system of incident resources may include any one of a smart phone, a laptop computer, a personal digital assistant (PDA), a portable multimedia player (PMP), a navigation device, a slate PC, a tablet PC, a desktop computer and the like. Such another computing device may display a graph database generated by the analysis system 100 to an administrator of a graph database generation system of the incident resources or a user of another computing device, through a graphical user interface (GUI). In this case, another computing device may also receive provision of a graphical user interface via the analysis system 100.

Although the collection system 50 and the analysis system 100 have been described as different configurations in FIG. 1, the constituent elements of the graph database generation system of incident resources may be configured in an integrated manner.

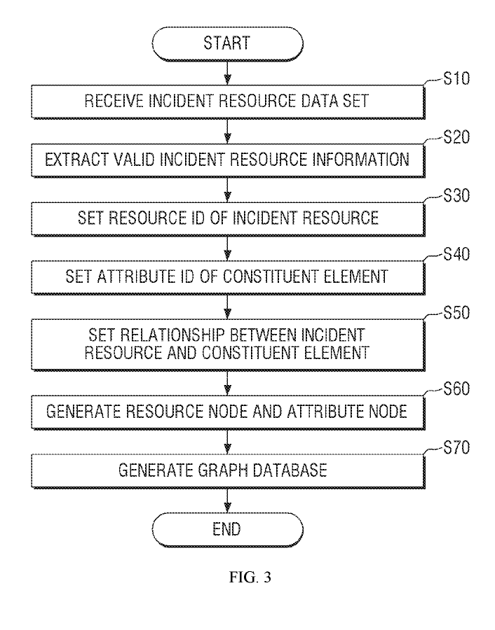

FIG. 2 is a hardware block diagram of a graph database generating apparatus of the incident resource according to another embodiment of the present invention. Hereinafter, the analysis system 100 is assumed to be a graph database generating apparatus 100 of incident resources.

Referring to FIG. 2, the graph database generating apparatus 100 of the incident resources may include one or more processors 101, a network interface 102, a memory 103 that loads a computer program 105 executed by the processor 10, and a storage 104 that stores the computer program 105.

The processor 101 controls the overall operations of each configuration of the graph database generating apparatus 100 of the incident resource. The processor 101 may be configured to include a central processing unit (CPU), a micro processor unit (MPU), a micro controller unit (MCU) or any form of processor well known in the technical field of the present invention. Further, the processor 101 may perform operations of at least one application or program for executing the method according to an embodiment of the present invention. The graph database generating apparatus 100 of the incident resources may include one or more processors.

The network interface 102 supports wired/wireless internet communication or intranet communication of the graph database generating apparatus 100 of the incident resource. Further, the network interface 102 may support various communication methods other than the internet communication and the intranet communication. To this end, the network interface 102 may include at least one communication module that is well known in the technical field of the present invention.

The network interface 102 may be connected to the collection system 50 and/or the monitoring target system via the network, and may also be connected another computing device. The network interface 102 may receive information on the collected incident resources, the incident resource data set and the monitoring result, and may transmit information on the correlation between the incident resources, the visualization result of the correlation, and various graphic user interfaces according to the embodiments of the present invention.

The memory 103 stores various data, commands and/or information. The memory 103 may load one or more programs 105 from the storage 104 to execute a method of generating a graph database of incident resources according to an embodiment of the present invention. The memory 103 may be, for example, a RAM, and may include at least one of various types of RAM which are widely used in the technical field to which the present invention belongs, such as SRAM, DRAM, PSRAM, SDPARM and DDR SDRAM. The memory 103 loads the computer program stored in the storage 104 so as to be executed by the processor 101.

In FIG. 2, as an example of the computer program 105, the graph database generation software 105 has been described. As the graph database generation software 105 is executed by the processor 101, one or more operations for executing the function and/or the action of the graph database generating apparatus 100 of the incident resources may be executed. This will be described in detail later in the description of FIG. 3.

The storage 104 may non-temporarily store the graph database generation software 105 exemplified as the computer program 105. Further, the storage 104 may also store the incident resource information database 106 according to the embodiment of the present invention. The incident resource information database 106 may store the incident resource data set collected from the collection system 50, and the information on which the regular expression is applied to the incident resource data set. Further, the incident resource information database 106 may also store various types of information related to incident resources, such as collection channels in which the incident resources are collected, the information on the infringement accidents caused by incident resources, and the like.

The storage 104 may be configured to include a nonvolatile memory such as a read only memory (ROM), an erasable programmable rom (EPROM), an electrically erasable programmable ROM (EEPROM) and a flash memory, a hard disk, a detachable disk, or any form of computer-readable recording medium that is well known in the technical field to which the present invention belongs.

Although it is not illustrated, the graph database generating apparatus 100 of the incident resources may also include a display. The display may output various interfaces that are utilized to perform the method according to embodiments of the present invention. Further, the display may also display a graph database which is an execution result of the graph database generation software, via the GUI.

On the other hand, in addition to the constituent elements illustrated in FIG. 2, the graph database generating apparatus 100 of the incident resources may further include various constituent elements related to the embodiment of the present invention. For example, the graph database generating apparatus 100 of the incident resources may also include an input unit for receiving inputs of the incident resources and various settings for incident resource inquiry from users and/or administrators.

Hereinafter, the operation of the graph database generating apparatus 100 of the incident resources will be described in more detail with reference to FIG. 3. The respective following steps are assumed to be executed by the graph database generating apparatus 100 of the incident resources. The graph database generating apparatus 100 of the incident resources may be abbreviated as a graphic database (GDB) generating apparatus 100 for convenience of explanation.

FIG. 3 is a flowchart of a method for generating a graph database of incident resources according to another embodiment of the present invention.

Referring to FIG. 3, the GDB generating apparatus 100 may receive the incident resource data set (S10). As described above, the GDB generating apparatus 100 may receive the incident resource data set from the collection system 50, but the embodiment of the present invention is not limited thereto, and the GDB generating apparatus 100 may also directly receive the incident resource data set from an external collection channel.

The GDB generating apparatus 100 may extract valid incident resource information from the incident resource data set (S20). The incident resource data set collected in the collection system 50 may have different data formats for each collection channel to which the incident resource data set is provided.

In such a case, in order to facilitate processing of the collected incident resource data set, the GDB generating apparatus 100 may apply a preset regular expression to the received incident resource data set. To this end, the GDB generating apparatus 100 may store the regular expressions in the storage 104 in advance. When the regular expressions are applied to the incident resource data set, the incident resource data set can be managed in a single unified form.

The GDB generating apparatus 100 may decide the previously set information as the valid incident resource information, among the information included in the incident resource data set to which the regular expressions are applied. For example, if the incident resource dataset is table-format data, all types of information on the table of the incident resource analysis may not be required. That is, only information recorded in a specific column on the table may be information useful for analysis of the incident resources. In this case, the GDB generating apparatus 100 decides only the information recorded on a specific column as the valid incident resource information, and may extract only the information recorded on a specific column, and may utilize the information for the incident resource analysis and the graph database generation of the incident resources. In the above example, a specific column of the incident resource data set to which the regular expression is applied may be set in advance as an extraction target of the GDB generating apparatus 100.

The GDB generating apparatus 100 may set a resource ID (hereinafter, referred to as RID) for the incident resources included in the valid incident resource information (S30).

At this time, based on the value of the incident resources included in the valid incident resource information, the GDB generating apparatus 100 may decide whether or not an incident resource overlapping the incident resource exists on the valid incident resource information. When there is no incident resource overlapping incident resource as a result of the determination, the GDB generating apparatus 100 may set the RID in the incident resource. This is to prevent a plurality of different IDs from being set for the overlapping incident resource, that is, the same incident resource. By assigning only one ID to the same incident resource, the graph database has a single node for the single incident resource.

For example, if the valid incident resource is a hash of the malicious code, an IP, domain or an E-mail, the GDB generating apparatus 100 may set the RID for each of them.

Next, the GDB generating apparatus 100 may set an attribute ID (hereinafter, AID) for a plurality of constituent elements of the incident resources (S40). In order to acquire a plurality of constituent elements from the incident resources, the GDB generating apparatus 100 may extract meta-data of the incident resources. The GDB generating apparatus 100 may identify the string of the extracted meta-data.

The GDB generating apparatus 100 may divide the identified string into at least one string. For example, the GDB generating apparatus 100 may divide the identified string into a first string and a second string. The GDB generating apparatus 100 may decide the divided first string and second string as the constituent elements of incident resources, and may set the AID in the first string and the second string, respectively.

According to the embodiment of the present invention, the GDB generating apparatus 100 may subdivide a constituent element in which an attribute ID is set, and in the above example, the divided first string into a first sub-string and a second sub-string. In addition, the GDB generating apparatus 100 may decide the subdivided first sub-string and second sub-string as constituent elements of incident resources, and may set the AID to the first sub-string and the second sub-string, respectively.

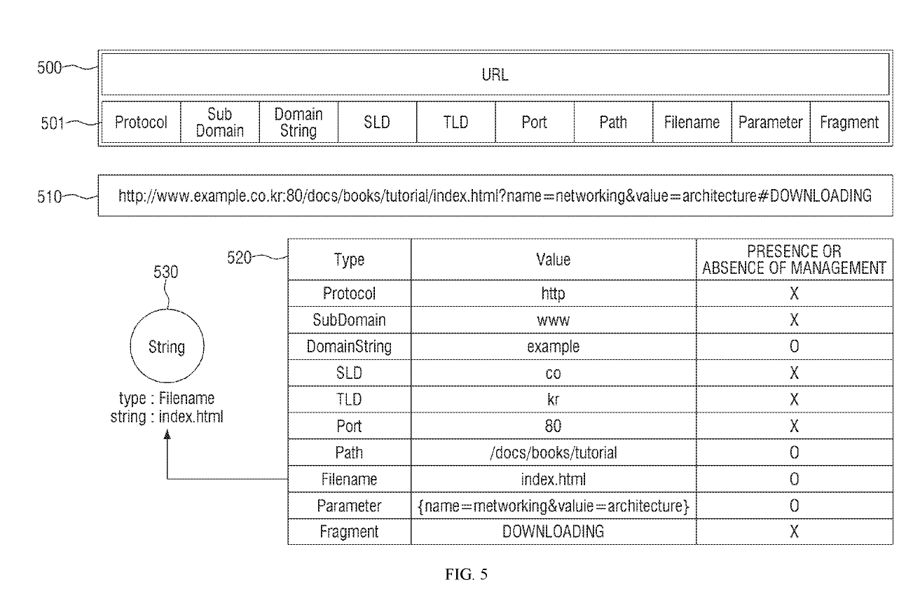

The criterion for the GDB generating apparatus 100 to divide the constituent elements of incident resources and the criteria for subdividing the divided constituent elements will be described later in the description of FIGS. 5 to 10.

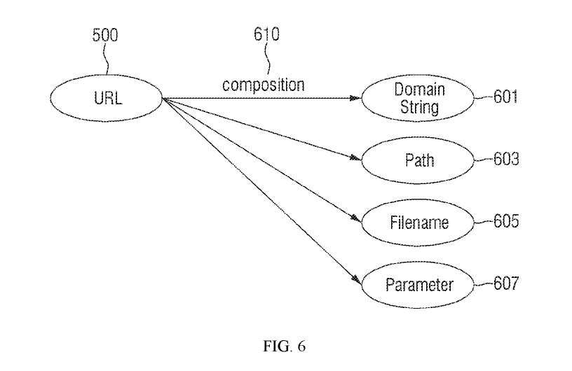

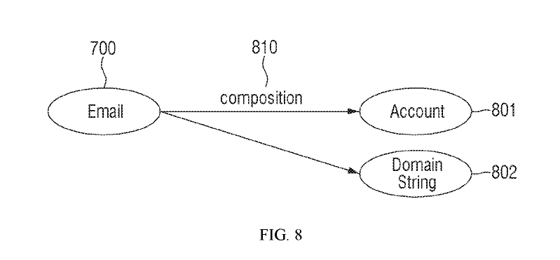

Next, the GDB generating apparatus 100 may set a relationship between the incident resources in which the RID is set and a plurality of constituent elements in which the AIDs are each set (S40). The GDB generating apparatus 100 may set the relationship between the incident resource in which the RID is set and the constituent element in which the AID is set, the relationship between a plurality of incident resources in which the different RIDs are set, and the relationship between the plurality of constituent elements in which the different AIDs are set. The relationship between the incident resources and the constituent elements will be described later in the description of FIGS. 6 and 8.

The GDB generating apparatus 100 generates a resource node of the incident resource based on the RID, and may generate each attribute node for a plurality of constituent elements based on the AID (S60). Here, the resource node of the incident resource is identified by the RID, and is a node in which information on the incident resource, for example, the value of the incident resource is mapped. Further, the attribute node is identified by the AID, and is a node in which information on the constituent element, for example, a value of the constituent element is mapped.

For example, if the incident resource is a hash of malicious code, the hash value is mapped to the resource node, and the resource node is identified by the RID. At this time, some strings with divided hash values are constituent elements of incident resources, some string values are mapped to the attribute nodes, and the attribute nodes may be identified by the AID.

The GDB generating apparatus 100 may generate a graph database connected with edge that indicates the relationship in which the resource node and the attribute nodes are set (S70). That is, the GDB generating apparatus 100 connects the resource node and the attribute node with an edge, and the edge may store a setting value of a relationship between the resource node and the attribute node.

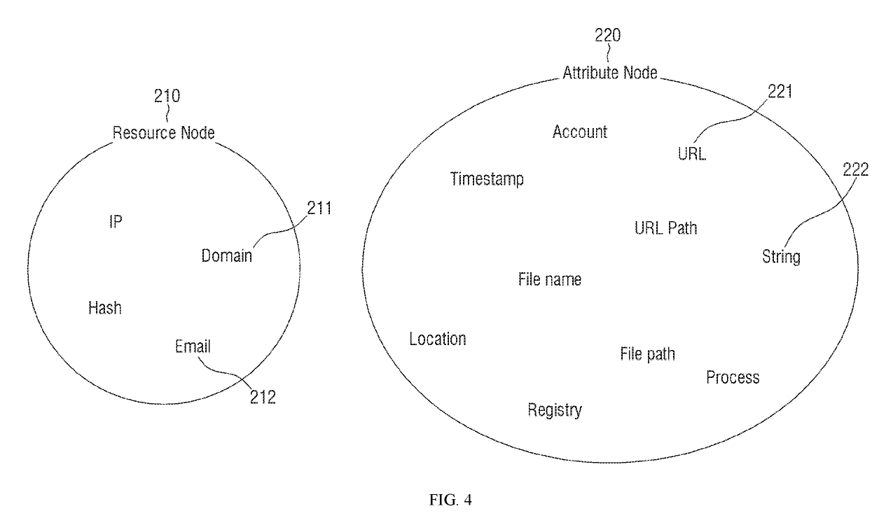

FIG. 4 is an exemplary view for illustrating nodes of a graph database, which is referred to in some embodiments of the present invention.

The analysis system 100 of FIG. 1 may divide the incident resource into a resource node and an attribute node generated in step S60 in order to store the incident resources collected in the collection system 50 in a graph database. For example, when the hash of a malicious code as the incident resource is received from the collection system 50, the GDB generating apparatus 100 may set the hash value of the received hash to the resource node and may assign the RID thereof. In addition, the GDB generating apparatus 100 may set a string as a constituent element of a hash value to an attribute node, and may assign the AID.

FIG. 4 illustrates each node which is set in the resource node 210, and each node which is set in the attribute node 220. For example, the resource node 210 may include a domain node 211, an E-mail node 212 and the like, and the attribute node 220 may include a URL 221, a string 222 and the like.

As illustrated in FIG. 4, the resource node 210 and the attribute node 220 may be managed as a group having different labels in the GDB generating apparatus 100, and the resource node 210 and the attribute node 220 may be mixed and connected to each other with the edges on the graph database generated in step S70.

FIG. 5 is an exemplary view for explaining a divisional management method of incident resources when the incident resource is a URL, which is referred to in some embodiments of the present invention. FIG. 5 illustrates the URL 500 as the incident resources and the semantic-based type 501 of the URL 500, and the string value 510 of URL 500 as the values of the incident resource values. Also, in FIG. 5, based on the semantic-based type 501 of the URL 500, information 520 about the divided constituent element and the exemplary attribute node 530 are illustrated.

The GDB generating apparatus 100 may divide the string of the meta-data extracted from URL 500 as the incident resource for each constituent element. Specifically, the GDB generating apparatus 100 may divide the URL 500 into strings of a plurality of constituent elements based on the semantic-based type that is registered in advance. The GDB generating apparatus 100 may identify that the incident resource is the URL 500, using the extracted meta-data, and may identify the semantic-based type 501 registered in advance for each constituent element of the URL 500, thereby dividing the incident resources into the constituent element strings. The semantic-based type 501 of the URL 500 may include Protocol, Sub Domain, Domain String, SLD, TLD, Port, Path, Filename, Parameter, Fragment, and the like. Each semantic-based type 501 one-to-one matches the constituent elements of the URL 500.

The information 520 of the divided constituent elements may include the semantic-based type 501 that matches the strings of each constituent element, string values of the strings of each constituent element, and information on the type of the managed object among the respective semantic-based types 501.

The type of the managed object means a type of the managed object in order to generate a graph database of incident resources, among the semantic-based types 501. That is, some of the constituent elements that match the semantic-based type 501 of incident resources are essential to the analysis of incident resources, and some others may be unnecessary for analysis of incident resources. In this case, the GDB generating apparatus 100 may decide only the constituent element matching the type of the managed object as the node on the graph database, as the type of the managed object among the semantic-based types 501 is managed separately.

To this end, the GDB generating apparatus 100 may previously set the type of information on the constituent element necessary for analysis of incident resources among the constituent elements of incident resources, and the semantic-based type 501 matching the necessary constituent elements may be set in advance in the GDB generating apparatus 100 as the type of the managed object.

With reference to the information 520 of the divided constituent element, Domain String, Path, Filename and Parameter of the semantic-based type 501 are set as the type of the managed object.

Accordingly, in step S40 of FIG. 3, when the semantic-based type corresponding to the constituent element string obtained by dividing the URL 500 string is included in the type of the managed object, the GDB generating apparatus may decide the constituent element string as the constituent element of the incident resources. Further, the GDB generating apparatus 100 may set the AID in the string decided as a constituent element of the incident resource.

The GDB generating apparatus 100 may identify the semantic-based type 501 or the type of the managed object as a reference, when the incident resource is divided into the constituent elements. Further, the GDB generating apparatus 100 may set a relationship between a resource node and an attribute node generated after the incident resource is divided in step S50 of FIG. 3 on the basis thereof.

In step S60 of FIG. 3, the GDB generating apparatus 100 may add information on the type of the managed object corresponding to the generated attribute node to the value of the attribute node.

Referring to the exemplary attribute node 530, the attribute node 530 to which the string is mapped may include information on the type of the managed object as well as the value of the attribute node. For example, the attribute node 530 stores index.html as the string value in the value of the attribute node, and may store the information Filename on the type of the managed object.

FIG. 6 is an exemplary view of a graph generated when the incident resource is a URL, which is referred to in some embodiments of the present invention. As illustrated in FIG. 5, as described above, it is assumed that the GDB generating apparatus 100 divides the URL 500 of incident resources, and Domain String, Path, Filename and Parameter are generated as constituent elements that match the type of the managed object.

On the basis thereof, a graph database may be generated in step S70 of FIG. 3. Referring to FIG. 6, in the GDB generating apparatus 100, the URL 500 is generated as a resource node, and a domain string 601, a path 603, a filename 605 and a parameter 607 as constituent elements may be generated as the attribute nodes.

In addition, the GDB generating apparatus 100 may connect a resource node and an attribute node with an edge. FIG. 6 illustrates a case where “composition” 610 indicating that the attribute node is a constituent element of the resource node is set in the relationship between the resource node and the attribute node. As a result, the GDB generating apparatus 100 may map the relationship of “composition” 610, which is set for the resource node and attribute node, to the edge.

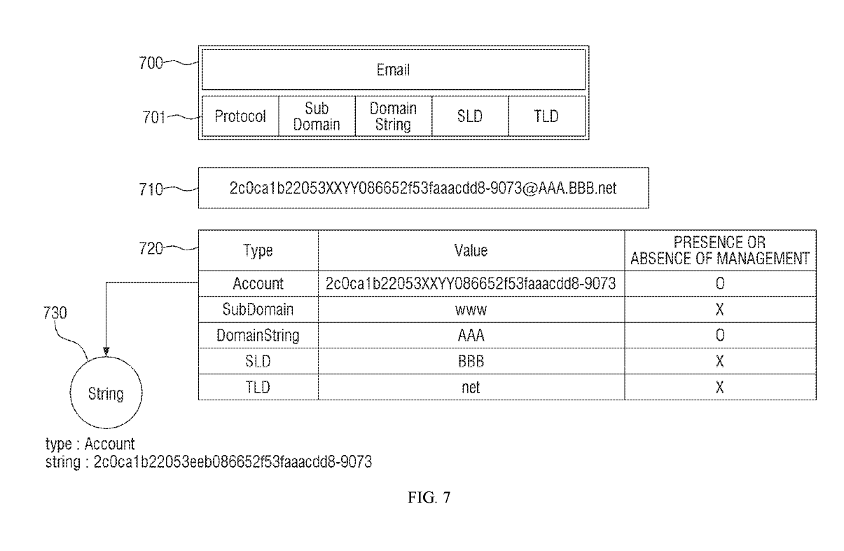

FIG. 7 is an exemplary view for explaining a divisional management method of incident resources in the case where the incident resource is an E-mail, which is referred to in some embodiments of the present invention. FIG. 7 illustrates an E-mail 700 as the incident resource and the semantic-based type 701 of the E-mail 700, and the string value 710 of the E-mail 700 is illustrated as the value of the incident resource. Also, in FIG. 7, based on the semantic-based type 701 of the E-mail 700, the information 720 of the divided constituent element and the example attribute node 730 are illustrated.

The GDB generating apparatus 100 may divide the string of the meta-data extracted from the E-mail 700 as the incident resource into strings of a plurality of constituent elements based on the semantic-based type registered in advance. The GDB generating apparatus 100 may identify that the incident resource is the E-mail 700, using the extracted meta-data, and may identify the semantic-based type 701 registered in advance for each constituent element of the E-mail 701 to divide the incident resource into constituent element strings. The semantic-based type 701 of E-mail 700 may include Account, Sub Domain, Domain String, SLD, TLD and the like.

Information on the divided constituent elements 720 may include the semantic-based type 701 that matches the strings of each constituent element, string values of strings of each constituent element, and information on the type of the managed object, among each semantic-based type 701. FIG. 7 illustrates a case where the account, the domain and the string are preset in the GDB generating apparatus 100, as the type of the managed object of the E-mail 700.

Accordingly, in the step S40 of FIG. 3, when the semantic-based type corresponding to the constituent element string obtained by dividing the E-mail 700 string is included in the type of the managed object, the GDB generating apparatus 100 may decide the constituent element string as a constituent element of incident resources. Further, the GDB generating apparatus 100 may set the AID in the string decided as a constituent element of the incident resource.

Referring to the exemplary attribute node 730, the attribute node 730 to which the string is mapped may include information on the type of the managed object as well as the value of the attribute node. For example, in the attribute node 730, a string value is stored as the value of the attribute node, and information account on the type of the managed object may be stored.

FIG. 8 is an exemplary view of a generated graph when the incident resource is E-mail, which is referred to in some embodiments of the present invention.

In step S70 of FIG. 3, a graph database may be generated. Referring to FIG. 8, in the GDB generating apparatus 100, an E-mail 700 is generated as the resource node, and an Account 801, a Domain string 802, a Filename 605 and a Parameter 607 as the constituent elements may be generated as the attribute nodes.

Further, the GDB generating apparatus 100 may connect a resource node and an attribute node with an edge. FIG. 6 illustrates a case where “composition” 810 indicating that the attribute node is a constituent element of the resource node is set in the relationship between the resource node and the attribute node. As a result, the GDB generating apparatus 100 may map the relationship of “composition” 810 set for the resource node and attribute node to the edge.

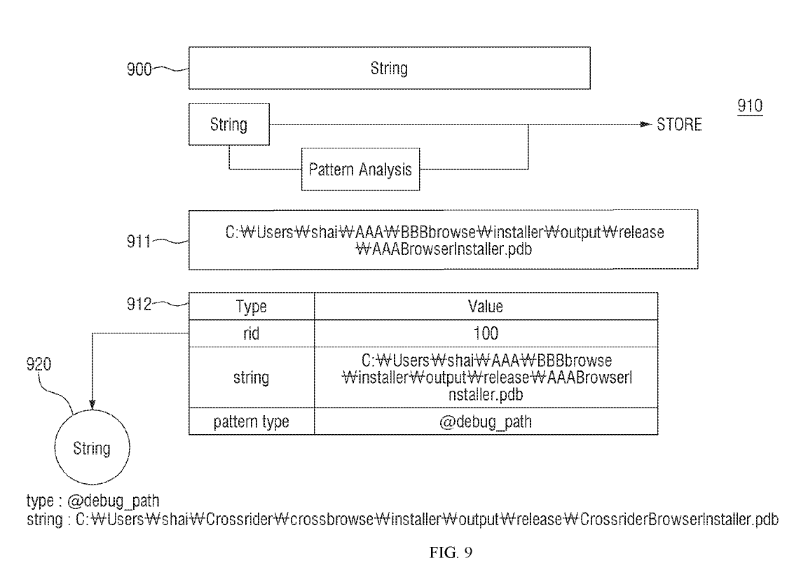

FIGS. 5 to 8 mainly explains a method in which the GDB generating apparatus 100 identifies the previously registered semantic-based type of the incident resources, and generates the nodes, using the constituent element which matches the type of the managed object, among the identified the semantic-based types. Embodiments of the present invention are not limited thereto, and when the GDB generating apparatus 100 does not identify the previously registered semantic-based type of the incident resource, it is possible to generate a pattern type for being applied to the resource node of the incident resources. Hereinafter, this will be described in detail with reference to FIG. 9.

FIG. 9 is an exemplary view of a method of specifying additional pattern types for the incident resource, which is referred to in some embodiments of the present invention. FIG. 9 illustrates a string 900 which is an incident resource, a pattern analysis process 910 of the string 900, a string value 911 of the string 900, a value 912 of the resource node including the pattern type specified to the string 900, and an exemplary resource node 920.

Referring to FIG. 9, the GDB generating apparatus 100 may extract meta-data of incident resources in step S20 of FIG. 3. As a result, the GDB generating apparatus 100 may identify the string 900 by the resource node.

The GDB generating apparatus 100 may determine whether the preset semantic-based type is identified with respect to the string of the extracted meta-data. As a result of the aforementioned determination, if the previously registered semantic-based type is not identified, the GDB generating apparatus 100 may analyze the pattern of the string of the meta-data.

Referring to the pattern analysis process (910), the GDB generating apparatus 100 may generate the pattern type of the string of the meta-data, based on the execution result of the pattern analysis. Here, the pattern type means a type which is assigned to the incident resource, based on the execution result of the pattern analysis of the GDB generating apparatus 100. As the pattern analysis, a pattern analysis method widely known in the technical field to which the present invention belongs may be used. For example, it is possible to use a pattern analysis method of analyzing the characters of the string to determine whether or not a common character string is repeated.

The GDB generating apparatus 100 may assign the generated pattern type to the string 900 as the type.

In step S60 of FIG. 3, the GDB generating apparatus 100 may add information on the generated pattern type to the value of the generated resource node. Referring to the value 912 of the resource node, the value 912 of the resource node may include RID of the resource node, the string value as the value of the resource node, and information on the pattern type specified for the resource node.

Referring to an exemplary resource node 920, a case in which a string value is stored as a node value in the resource node, and a pattern type @debug_path is specified is illustrated as an example.

In step S70 of FIG. 3, it is possible to generate a graph database in which the resource nodes and other resource nodes are connected to each other by edges, based on information on the pattern type of the GDB generating apparatus 100. That is, the GDB generating apparatus 100 may set the relationship between the first resource node and the second resource node as the information on the pattern type. Accordingly, the first resource node and the second resource node may be connected to each other by the edge that indicates information on the pattern type.

Also, on the basis of information on the pattern type of the GDB generating apparatus 100, it is possible to generate a graph database in which the resource node and the attribute node of other resource node are connected to each other by edges. That is, the first resource node may also be connected to the attribute node mapped to the constituent element of the second resource node, based on information on the pattern type.

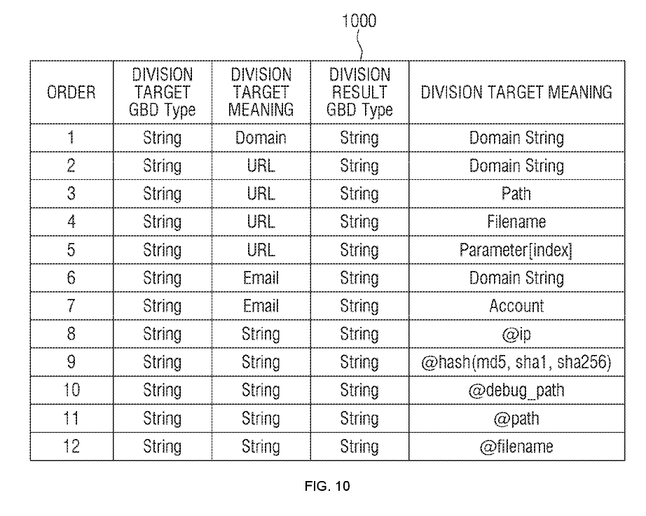

FIG. 10 is an exemplary view for explaining a relationship between a resource node and an attribute node according to the division result of the incident resource, which is referred to in some embodiments of the present invention.

Referring to FIG. 10, the division object GDB type may be a type of incident resources. The incident resource is extracted from the meta-data and is mainly a string. According to the embodiment of the present invention, RID may be set in the string corresponding to the division target GDB type, by the GDB generating apparatus 100. The division target meaning is an incident resource which is identified from the meta-data of the incident resource.

The division result GDB type may be a type of constituent element of the incident resource. Since the division target string is divided, the result is also a string. The AID may be set in the division result string, by the GDB generating apparatus 100.

The division result meaning may be the aforementioned semantic-based type. Also, the division result meaning may also be the generated pattern type.

The GDB generating apparatus 100 may generate a resource node mapped to a string corresponding to the division target GDB type based on the RID, and may generate an attribute node mapped to the string corresponding to the division result GDB type based on the AID. Further, the GDB generating apparatus 100 may connect the resource node and the attribute node to each other by the edge which indicates the division result meaning.

On the other hand, in step S60 of FIG. 3, the GDB generating apparatus 100 may compare the values of the first attribute node with the second attribute node included in the generated attribute node. As a result of the determination, if the value of the first attribute node is equal to the value of the second attribute node, the GDB generating apparatus 100 may generate the attribute node having the value of the same node.

When the attribute nodes having the same node value are generated, the attribute nodes exist on the graph database in an overlapping manner. At this time, if the overlap attribute nodes have another type, the GDB generating device 100 may manage this with another attribute node.

In order to manage the attribute node having the same node value with another attribute node, the GDB generating apparatus 100 may specify the first pattern type to the first attribute node, and may specify the second pattern type to the second attribute node. To this end, the GDB generating apparatus 100 may perform the pattern analysis on the value of the first attribute node and the value of the second attribute node, thereby deciding the first pattern type of the first attribute node, and deciding the second pattern type of the second attribute node. The GDB generating apparatus 100 may add the decided first pattern type to the value of the first attribute node, and may add the decided second pattern type to the value of the second attribute node.

As a result, even if the node values of the first attribute node and the second attribute node are the same except for the pattern type, the GDB generating apparatus 100 may generate both of the first attribute node and the second attribute node and separately manage both of them.

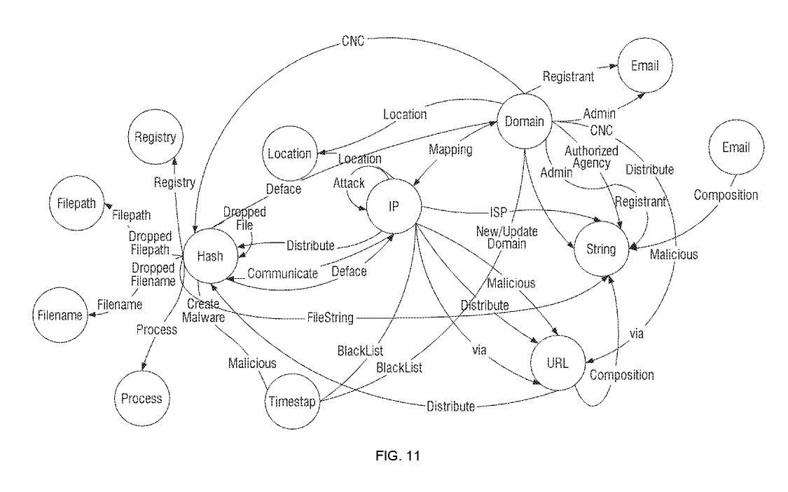

FIG. 11 is an example of a graph database which is referred to in some embodiments of the present invention.

Referring to FIG. 11, the GDB generating apparatus 100 may generate a graph database, by generating a resource node and an attribute node and by setting the relationship therebetween to the edge. FIG. 11 illustrates the graph database which is built and stored in the GDB generating apparatus 100, as an example.

Referring to FIG. 11, the resource node and the attribute node of the graph database may be connected to each other with the edge, and the resource nodes or the attribute nodes may be connected to each other with the edges. FIG. 11 illustrates the relationship of each node connected to each other with the edge.

While the present invention has been particularly illustrated and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. A method for generating graph database of incident resources, the method comprising:
receiving an incident resource data set;
extracting valid incident resource information from the incident resource data set;
setting a resource ID for a incident resource included in the valid incident resource information;
setting each attribute ID for a plurality of constituent elements of the incident resource;
setting a relationship between the incident resource in which the resource ID is set and the plurality of constituent elements in which the attribute ID is each set;
generating a resource node of the incident resource based on the resource ID;
generating each attribute node of the plurality of constituent elements based on the attribute ID; and
generating a graph database in which the resource node and the attribute node are connected to each other by an edge indicating the set relationship.

2. The method of claim 1, wherein setting each attribute ID for the plurality of constituent elements of the incident resources comprises:
extracting meta data of the incident resource;
dividing the string of the extracted meta data into a first string and a second string;
determining the first string and the second string as the constituent elements of the incident resource; and
setting the attribute ID in each of the first string and the second string.

3. The method of claim 2, further comprising:
dividing the first string into a first sub-string and a second sub-string;
determining the first sub-string and the second sub-string as the constituent element of the incident resource; and
setting an attribute ID for each of the first sub-string and the second sub-string.

4. The method of claim 2, wherein dividing the string of the extracted meta data into the first string and the second string comprises:
dividing the string of the meta data into the first string and the second string based on a preset semantic-based type, and
wherein the setting each attribute ID for a plurality of constituent elements of the incident resource comprises:
determining a string corresponding to a type of a managing object as a constituent element of the incident resource, when at least one of a first semantic-based type corresponding to the first string and a second semantic-based type corresponding to the second string is included in the type of the managing object; and
setting an attribute ID in the string determined as the constituent element of the incident resource.

5. The method of claim 4, wherein generating each attribute node for the plurality of constituent elements based on the attribute ID comprises:
adding information on the type of the managing object corresponding to the generated attribute node to the value of the attribute node.

6. The method of claim 1, wherein setting the resource ID for the incident resource included in the valid incident resource information comprises:
extracting meta data of the incident resource;
determining whether a preset semantic-based type is identified to the string of the extracted meta-data;
executing a pattern analysis of a string of the meta data, when the preset semantic-based type is not identified as a result of determination; and
generating a pattern type of the string of the meta data, based on the execution result of the pattern analysis,
wherein the generating the resource node of the incident resource based on the resource ID comprises adding information on the generated pattern type to the value of the generated resource node.

7. The method of claim 6, wherein the generating the graph database in which the resource node and the attribute node are connected to each other by an edge indicating the set relationship comprises:
generating a graph database in which the resource node and the attribute node of another resource node are connected to each other by edges, based on information on the pattern type.

8. The method of claim 7, wherein the generating the graph database in which the resource node and the attribute node of another resource node are connected to each other by the edges comprises:
generating a graph database in which the resource node and the attribute node of another resource nodes are connected to each other by the edges, based on information on the pattern type.

9. The method of claim 1, wherein the setting the resource ID for the incident resources comprises:
determining whether there is a first incident resource duplicated with the incident resource on the valid incident resource information, based on a value of the incident resource; and
setting the resource ID in the incident resource, when there is no first incident resource duplicated with the incident resource, as a result of the determination.

10. The method of claim 1, wherein the generating each attribute node for the plurality of constituent elements based on the attribute ID comprises:
comparing values of a first attribute node and a second attribute node included in the generated attribute node with each other;
specifying the first pattern type to the first attribute node and specifying the second pattern type to the second attribute node, when the value of the first attribute node is equal to the value of the second attribute node as a result of the determination; and
generating the first attribute node and the second attribute node, when the first pattern type and the second pattern type are different from each other.

11. The method of claim 10, wherein specifying the first pattern type to the first attribute node and specifying the second pattern type to the second attribute node comprises:
performing a pattern analysis on each of the value of the first attribute node and the value of the second attribute node to determine the first pattern type of the first attribute node and determine the second pattern type of the second attribute node; and
adding the determined first pattern type to the value of the first attribute node and adding the determined second pattern type to the value of the second attribute node.

12. The method of claim 1, wherein the extracting the valid incident resource information from the incident resource data set comprises:
applying a preset regular expression to the received incident resource data set; and
determining preset information, among information included in the incident resource data set to which the regular expression is applied, as the valid incident resource information.

13. A computer program, for generating a graph database of incident resources, which is coupled with a computer device and stored in a non-transitory computer readable recording medium, the program being configured to execute:
receiving an incident resource data set;
extracting valid incident resource information from the incident resource data set;
setting a resource ID for the incident resource included in the valid incident resource information;
setting an attribute ID for a constituent element of the incident resource;
setting a relationship between the incident resource in which the resource ID is set and the constituent element in which the attribute ID is set;
generating a resource node of the incident resource based on the resource ID;
generating an attribute node of the constituent element based on the attribute ID; and
generating a graph database in which the resource node and the attribute node are connected to each other by an edge indicating the set relationship.

14. An apparatus for generating graph database of incident resources, the apparatus comprising:
one or more processors;
a memory configured to load a computer program executed by the processors;
a network interface configured to receive an incident resource data set from the collection system; and
a storage configured to store the computer program and the incident resource data set,
wherein the computer program comprises:
an operation of receiving the incident resource data set;
an operation of extracting valid incident resource information from the incident resource data set;
an operation of setting a resource ID for the incident resource included in the valid incident resource information;
an operation of setting an attribute ID for each of the plurality of constituent elements of the incident resource;
an operation of setting a relationship between the incident resource in which the resource ID is set and the plurality of constituent elements in which the attribute ID is set;
an operation of generating a resource node of the incident resource, based on the resource ID;
an operation of generating attribute node for each of the plurality of constituent elements based on the attribute ID; and
an operation of generating a graph database in which the resource node and the attribute node are connected to each other by edge indicating the set relationship.
